(19) United States
(12) Patent Application Publication
(10) Pub. No.: US 2010/0058710 A1
(43) Pub. Date: Mar. 11, 2010

(54) POLE MADE FROM A PLURALITY OF WOOD BOARDS AND METHOD OF MAKING SAME

(75) Inventor: Jacques Girard, Saint-Felicien (CA)

Correspondence Address: CANTOR COLBURN, LLP, 20 Church Street, 22nd Floor, Hartford, CT, 06103, US

(73) Assignee: 9161-7225 QUEBEC INC., Roberval (Quebec) (CA)

(21) Appl. No.: 12/515,288

(22) PCT Filed: Nov. 22, 2007
(86) PCT No.: PCT/CA07/02112

§ 371 Date: Oct. 22, 2009

(51) Int. Cl. E04H 12/04; E04C 3/12; B27M 3/00; B27M 3/32

(52) U.S. Cl. 52/836; 144/350; 144/344

(57) ABSTRACT

The pole can include a plurality of elongated panels, the elongated panels being oriented substantially longitudinally relative to an axis of the pole and being face-joined in a stacked arrangement. Each one of the elongated panels can be an assembly of substantially longitudinally-oriented wood boards. The method can include face joining a plurality of elongated panels into an elongated stack, where each one of the elongated panels can be an assembly of substantially longitudinally-oriented wood boards.

### BACKGROUND

Solid wood poles are commonly used for example as a structure for supporting municipal electricity distribution wires. Such solid wood poles are typically made from solid timbers of a relatively large size and a relatively high wood grade. However, with the intensified forestry activities which have taken place during recent years, timbers of a sufficient size for making such wood poles are becoming scarcer. Furthermore, such large timbers can alternately be used in other wood products and perhaps be more profitable as such. There was thus a need for a substitute to wood poles, or other similar products, made from relatively large solid timbers.

### SUMMARY

In accordance with one aspect, there is provided a pole made from a plurality of face-joined elongated panels, wherein the elongated panels themselves can be made of an assembly of a plurality of wood boards.

The original stacked arrangement of the face-joined elongated panels is typically somewhat rectangular. It can be used as such, as a pole having a somewhat rectangular cross-section, or it can be turned to obtain a pole having a solid of revolution shape, for example. The cross-section of the pole can vary along the length of the pole. For example, the pole can be broader at a lower, base portion, and then gradually decrease in cross-sectional area along the remaining length and have a narrower tip. The obtained pole can be used vertically or horizontally in different applications.

The wood boards can have the same thickness, but varying lengths and varying widths, which can allow using wood boards of initially different dimensions and potentially having a relatively low grade or value, and/or obtaining joints between the wood boards which are substantially offset between adjacent panels, which can result in better structural resistance.

The stacked construction of the pole can allow incorporating a longitudinal passageway in the pole. This can be achieved, for example, by using one or more elongated panels which have a longitudinally-extending discontinuity in the stacked arrangement.

In accordance with another aspect, there is provided a pole comprising a plurality of elongated panels, the elongated panels being oriented substantially longitudinally relative to an axis of the pole and being face-joined in a stacked arrangement, each one of the elongated panels being an assembly of substantially longitudinally-oriented wood boards

In accordance with another aspect, there is provided a method of making a pole comprising: face-joining a plurality of elongated panels into an elongated stack, each one of the elongated panels being an assembly of substantially longitudinally-oriented wood boards.

In accordance with another aspect, there is provided a method of making poles, comprising: face joining a plurality of elongated panels into an elongated stack, each one of the elongated panels being comprised of an assembly of substantially longitudinally-oriented wood boards; and separating the elongated stack substantially in the longitudinal direction into at least two poles by separating each one of the elongated panels.

The separation can be done with a sloping cut to define respective and opposite broader base portions and narrower upper portions in two originally adjacent poles.

In accordance with still an other aspect, there is provided a wood pole comprising: a plurality of face joined elongated panels in a stacked configuration, each elongated panel being comprised of at least two end-joined panel sections, each panel section being comprised of a plurality of side-joined wood boards.

In accordance with still an other aspect, there is provided a process of making a wood pole comprising: forming at least three elongated panels of equal contour dimensions, each elongated panel being formed by end-joining at least a first panel section having a given thickness and a first width to a second panel section having the given thickness and a second width different from the first width; and face joining the at least three elongated panels.

In accordance with still an other aspect, there is provided a process of making a wood pole comprising: face-joining a first elongated panel to at least a second elongated panel having roughly the same dimensions as the first elongated panel, into a wood assembly; and defining a longitudinal cut, which can be sloping or straight, in the wood assembly to separate a wood pole from a remaining portion of the wood assembly. The cut can be made along a plane being in the direction of the thickness of the elongated panels, for example.

### DESCRIPTION OF THE FIGURES

FIG. 1 includes FIG. 1A and FIG. 1B, which are perspective views of an example of a pole;

FIG. 2 is a schematic view of an example of a method of making panel sections for use in the pole of FIG. 1;

FIG. 3 is a perspective view, fragmented, of an example of an elongated panel for use in the pole of FIG. 1;

FIG. 4 shows the outline of the elongated panels used in the pole of FIG. 1;

FIG. 5 shows the assembly which results from face-joining the elongated panels of FIG. 4;

FIG. 6 includes FIG. 6A and FIG. 6B, which are perspective views of another example of a pole;

FIG. 7 includes FIG. 7A and FIG. 7B, which are perspective views of an assembly of elongated panels before and after substantially longitudinal separating into two assemblies.

### DETAILED DESCRIPTION

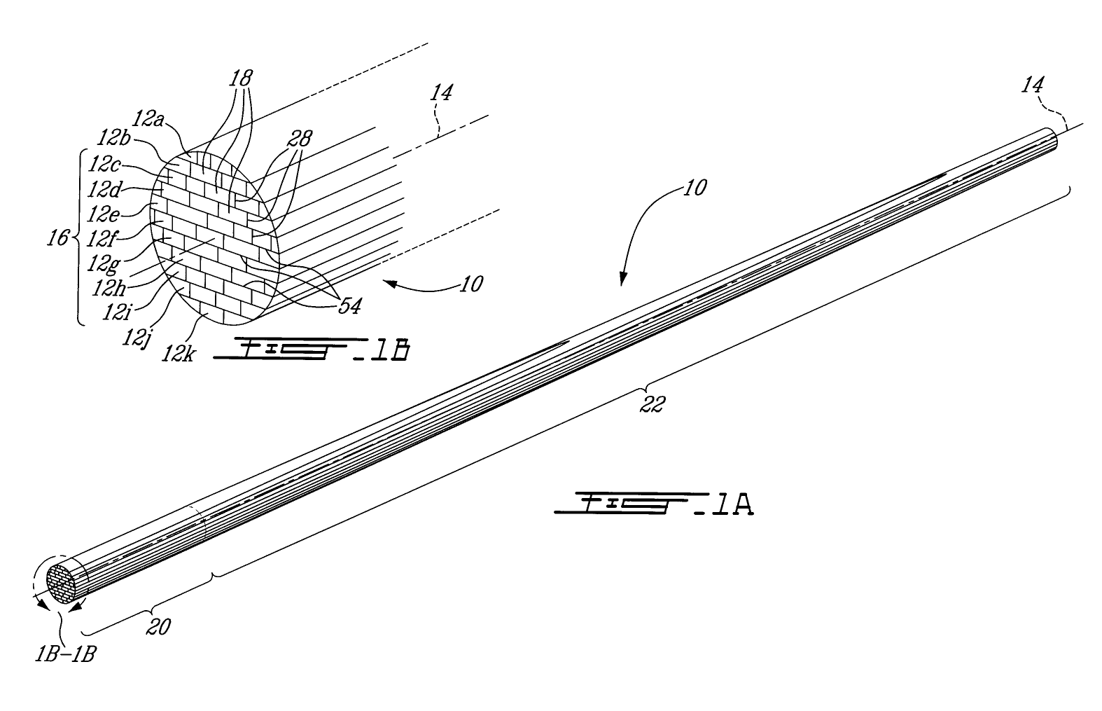

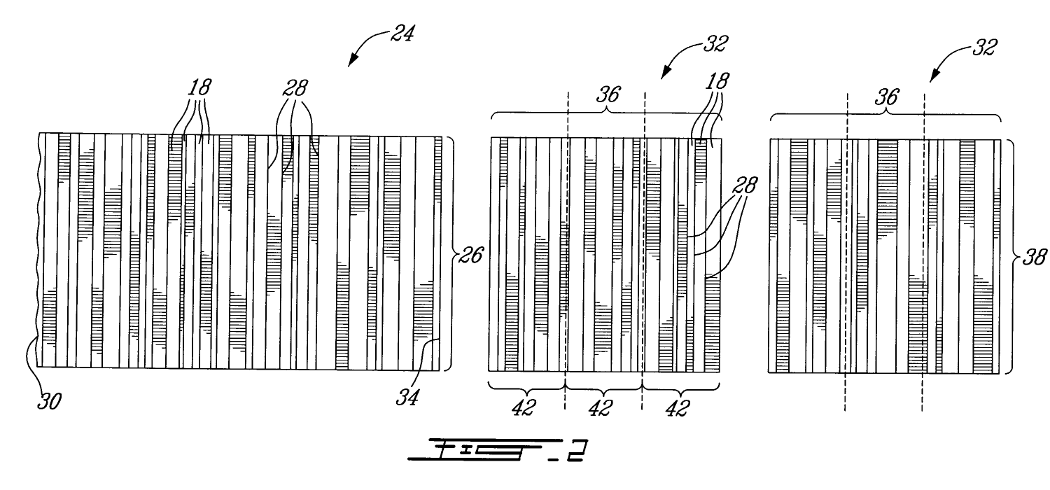

FIG. 1 shows an example of a pole 10. This example is given for illustrative purposes only and is not to be interpreted as limiting the scope in any way. This example of a pole 10 includes a plurality of elongated panels 12a to 12k. The elongated panels 12a to 12k are oriented in the longitudinal orientation of the pole 10, i.e. substantially in the same orientation as the pole axis 14. The elongated panels 12a to 12k are face-joined to one another in a stacked arrangement 16. Each one of the elongated panels 12a to 12k is an assembly of a plurality of wood boards 18.

In this example, the pole 10 is generally shaped as a solid of revolution having a base portion 20 shaped as a cylinder, and an upper portion 22 in the shape of a truncated cone.

Depending on the type of wood and adhesive used in the assembly, the joints between wood boards, either longitudinal or transversal, can be an area of structural weakness. If the joints between the wood boards in one elongated panel coincide with the joints between the wood boards in an adjacent elongated panel the stack 16, this potential weakness can extend transversally across the resulting pole 10. This possible drawback can be reduced by using a method of assembly of the pole 10 which provides a reduced likelihood of coinciding joint occurrences between adjacent elongated panels. An example of one such method will now be described for illustrative purposes, although it is to be understood that alternate poles can be assembled using any suitable alternate method, depending on the particular application.

In this example, wood boards of a relatively low grade can be used as the starting material. The wood boards can have defects, such as occurrences of bark on a portion of an edge thereof, or a large knot or other irregularity at a given longitudinal position therealong. One can start off with a batch of wood boards having the same thickness, but optionally having differing widths or lengths. For illustrative purposes, the starting boards can include 2×3, 2×4, and 2×6 wood boards, having a length between 6 and 16 feet, or any other suitable dimensions.

In this example, the starting boards are first cut to obtain a plurality of wood boards having the same length. Typically, the length will be selected to be an entire fraction of the starting length of the boards. For example, the common length can be chosen to be 4 feet (48 inches), when one starts off with 8 foot, 12 foot, or 16 foot long boards.

These same-length boards are then individually positioned on a conveyor in a manner that acceptable defects are all oriented on the same side. The boards are then machined longitudinally to remove the defect. If a tongue and groove joint is to be used in the later edge-joining of the boards, the machining step can make the mating tongue and groove shapes on opposite edges of the board while removing the desired width from the board. The amount of width which is removed from the board depends on the width of the defect. The resulting boards 18 are substantially free of occurrences of longitudinally extending defects and have the same length. The resulting boards 18 also have substantially randomly varying widths, due to the varying original widths of the boards and/or the width of any defect which was removed.

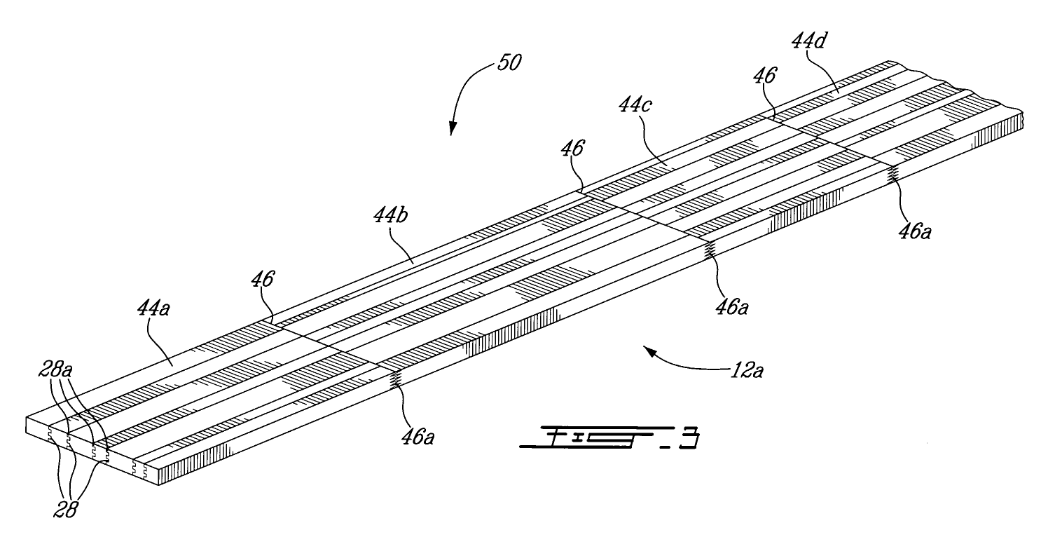

These resulting boards 18 can then be edge-joined into a panel 24 of transversally-extending boards, such as illustrated in FIG. 2. This panel 24 has a given width 26 which is determined by the common length of the wood boards 18 which compose it. This width 26 can be of 4 feet in this example. The joined edges 28 of the paneled boards 18 can be flat, or a tongue and groove arrangement can optionally be used, for example, to obtain a greater amount of structural stiffness. Any suitable alternate edge joints 28 can be used as well. In this example, a plurality of boards 18 are continuously paneled on one side 30 of the transversal panel 24, and base panels 32 of a common width 36 are repeatedly removed from the other side 34 of the transversal panel 24 by sawing. The resulting base panels 32 thus have both a common width 36 and a common length 38.

The common width 36 of the base panels 32 can be selected as a function of the size of the pole 10 to assemble. In this example, it was predetermined that panel sections 42 having a width of about 14.5 inches were desired. A common width 36 of about 43.5 inches was thus selected for the base panels 32, and the 43.5 inch base panels 32 were thereafter cut into three 14.5 inch wide base panel sections 42.

In this example, a plurality of base panel sections 42 having 4 feet in length and 14.5 inches in width were thus obtained. In these base panel sections 42, the wood boards 18 are oriented lengthwisely, and have randomly varying widths, for reasons discussed above. The probability that one or more of the joints 28 between the wood boards 18 of two randomly selected ones of such base panel sections 42 would be positioned at the same transversal position is thus relatively low.

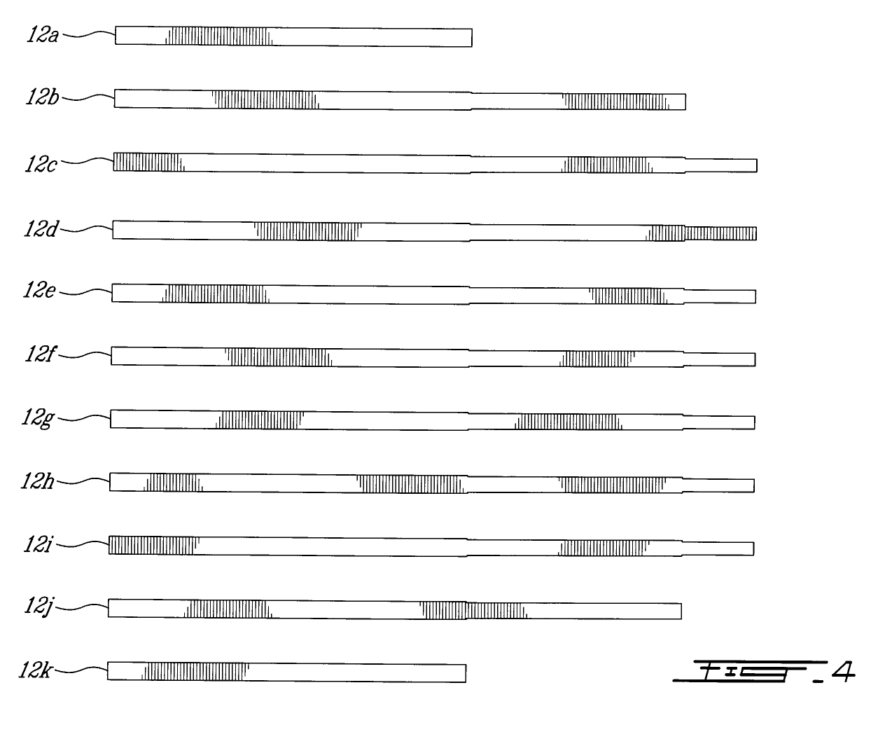

In this example, these 4′ L×14.5″ W base panel sections 42 can then trimmed down in length, to selectively eliminate defects which were not originally positioned on an edge of the wood boards 18. Because these defects occur rather randomly, the length of the panels which is trimmed off is random, and the resulting panel sections 44a, 44b, 44c, 44d (FIG. 3) can have the same thickness and the same width, but typically have randomly-varying lengths.

Base panel sections 42 which do not have any defects can either be used directly as panel sections 44a, 44b, 44c, 44d for the pole, or be cut into two or more panel sections, as desired.

The panel sections 44a, 44b, 44c, 44d obtained thus have varying lengths, and are then end-joined into elongated panels 12a to 12k for use in the pole 10 (see FIGS. 1 and 3). The end-joints 46 in the elongated panels 12a to 12k can be finger-joints 46a, or any other suitable end-joint 46.

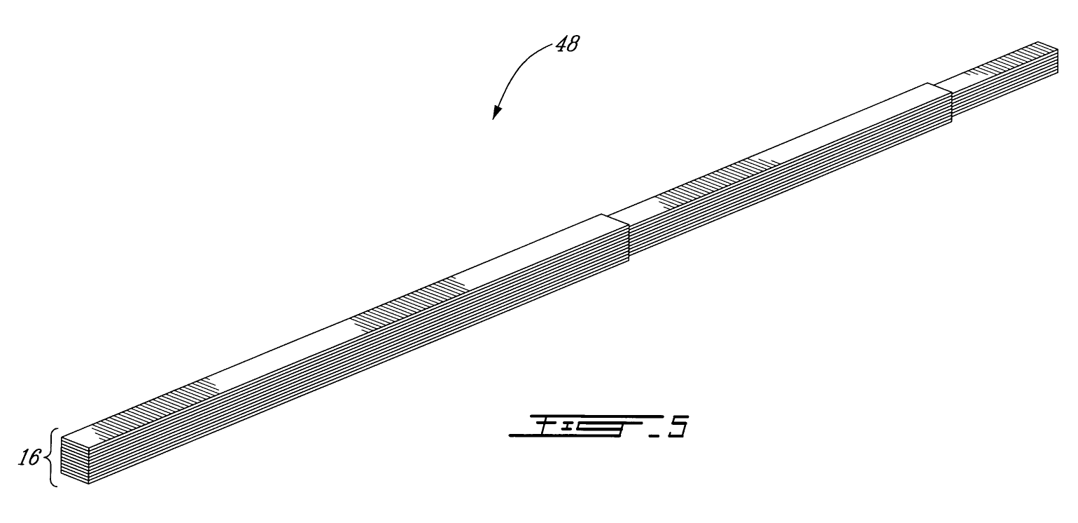

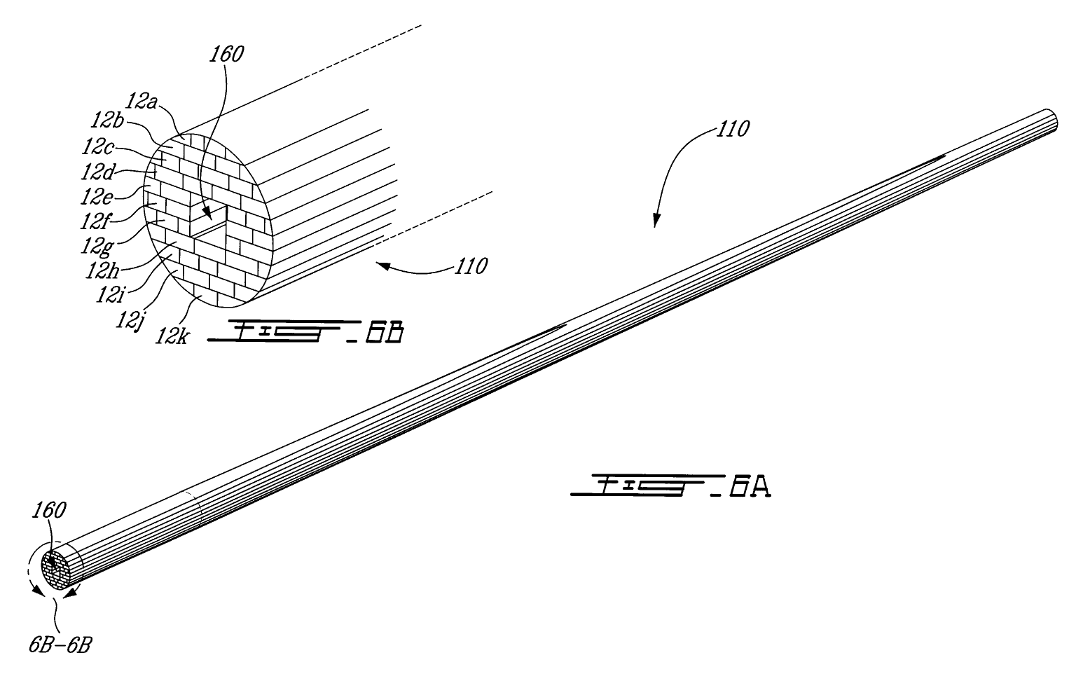

The elongated panels 12a to 12k obtained (FIG. 4) can then be face-joined into a stacked arrangement 16, such as the elongated stack 48 shown in FIG. 5, and subsequently turned to obtain a solid of revolution shape such as depicted in FIG. 1. This will be detailed further below.

It is now understood that elongated panels made by the example method described above can have an assembly of wood boards 18 which are joined longitudinally 46 and transversally 28 (FIG. 3) at substantially random joint positions. The likelihood of finding one joint, either a transversal joint 28 or a longitudinal joint 46, which extends transversally across two or more of the stacked elongated panels 48 (FIG. 5) is thus considerably low.

Many various shapes, widths, and lengths of poles can be made, because there is practically no limit on the amount of individual wood boards which can be assembled together. Further the individual wood boards can be assembled in a plurality of different ways.

Perhaps the simplest pole design is a pole of rectangular prism shape having a constant size cross-sectional area along the entire length. Such a pole can be turned to obtain to transforms the elongated rectangular prism shape of the pole into a solid of revolution shape, such as an elongated cylinder for example.

In poles of the type which are commonly used for carrying municipal electricity cables, there is a greater need for structural resistance at the base portion of the pole than at the upper portion of the pole. The amount of wood used can thus be reduced by designing a pole which has an upper portion of truncated conical shape, and thus has a narrower upper end, and a broader base, or lower end. Such poles can be made from stacks of elongated panels which are individually shaped as a function of the final pole design. To give an example of how elongated panels can be adapted to the particular pole design, discussion will be made with respect to the pole 10 illustrated in FIG. 1.

The pole 10 (FIG. 1) has an overall length of 45 feet. The pole 10 is designed with a cylindrical base portion 20, having a diameter of about 14.5 inches over a length of 6 feet, and an upper portion 22 of truncated conical shape spanning the remaining 39 feet of the pole 10, along which the diameter linearly decreases from about 14.5 inches to a tip diameter of about 8.5 inches. To achieve the base width of 14.5 inches, a total of 11 elongated panels 12a to 12k are stacked. These 11 elongated panels 12a to 12k are outlined in FIG. 4.

The specific design of each one of the elongated panels 12a to 12k is adapted for its specific position in the stack 48 (FIG. 5), as a function of the final pole design. The central elongated panels 12c to 12i are thus longer than the other, lateral elongated panels 12a, 12b, 12j, 12k.

To make the specific 11 elongated panels 12a to 12k shown in FIG. 4, panel sections (44a, 44b, 44c, 44d . . . FIG. 3) of three different widths were used. In a first step, the panel sections 44a, 44b, 44c, 44d . . . , having the base with of 14.5 inches and varying lengths as described above, were end-joined until a 14.5 inch wide panel 50 (FIG. 3) having a length of at least 25 feet was obtained. Elongated panels 12a and 12k require no more panels and were thus considered completed at this stage. To assemble the other elongated panels 12b to 12j, panel sections having varying lengths and a common width of about 13 inches were then centrally end joined to the previous assembly 50 until a total length of at least 40 feet was reached. Elongated panels 12b and 12j required no more panel sections and were thus considered completed at this stage. To assemble the remaining elongated panels 12c to 12i, panel sections having varying lengths and a common width of about 10 inches were further centrally end joined to the 40 foot long assembly until the total length of at least 45 feet was reached. These elongated panels were then trimmed down to 45 feet. It is to be noted that a different combination of lengths and widths of panel sections can alternately procure overall dimensions sufficient to turn the above-described pole shape.

These elongated panels 12a to 12k were then stacked into the configuration illustrated in FIG. 5, and subsequently turned to obtain the desired shape, which is depicted in FIG. 1.

It is thus an interesting feature of a pole made of an assembly of wood boards that many particular designs can be imagined, and can be realized by designing a number of elongated panel configurations which, when stacked, will allow the particular design to be turned.

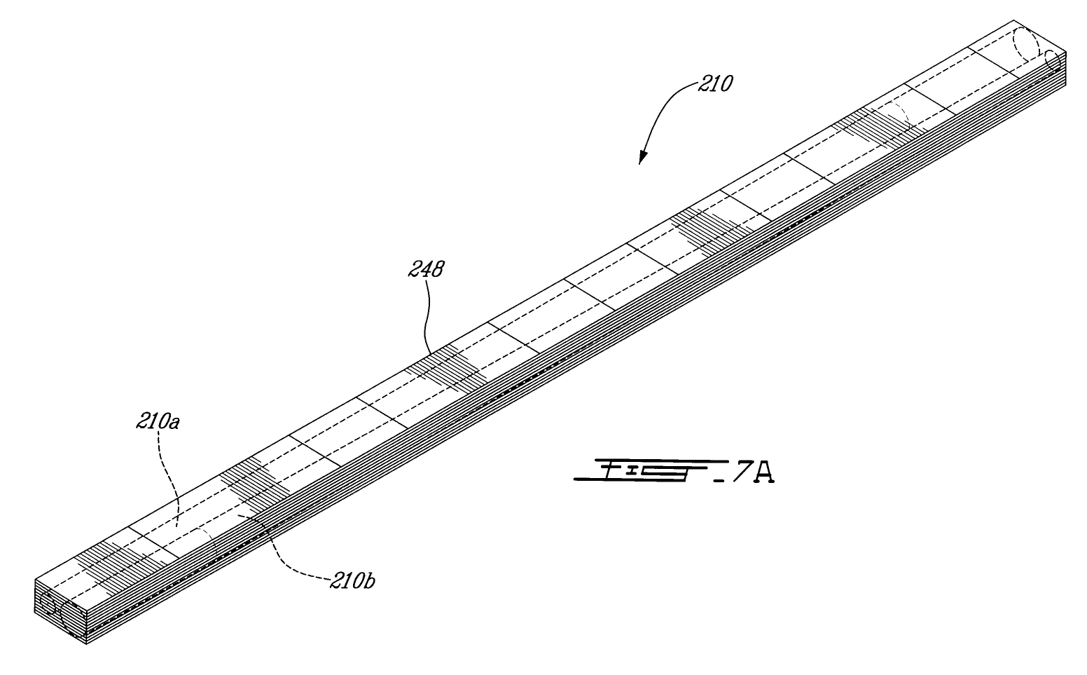

Another interesting feature of a pole made of an assembly of wood boards is that it becomes possible to make a pole design which has a cavity therein, such as a longitudinal passage, for example. An example of a pole 110 having a longitudinal passage 160, but otherwise similar to the pole 10, is depicted in FIGS. 6A and 6B. In such a pole 110, one or more of the elongated panels 112a to 112k, typically ones which are designed to be at or near the center of the pole 110, can have a longitudinal discontinuity which can be defined along a central portion thereof. In other words, one or more of the elongated panels can actually include two narrower panels with a spacing therebetween. The two narrower panels can be individually assembled by end-joining relatively narrower panels, or can be obtained by longitudinal sawing. To ease stacking, a filler material, such as a panel of expanded polystyrene for example (not shown), can be used to fill the longitudinal passage and thus maintain the thinner panels in position during the face-joining. This filler material can be removed afterwards. Any suitable filler material can be used. The longitudinal passage so designed can be provided in the core of the wood pole 110. The exact cross-sectional shape of such a longitudinal passage can vary and can be specifically designed in view of particular applications.

For example, in the case of a wood pole used for supporting electric wires, the longitudinal passage can be designed to allow to passage of wires therethrough. In another aspect, when unusually strong winds such as hurricanes occur, some wood poles may break. The longitudinal passage can thus be used to incorporate a structural element into the remaining undamaged portion of the wood pole, and thus allow to repair the damaged wood poles by repositioning an upper portion of the wood pole and affixing the upper portion of the wood pole to the structural element and/or to the lower portion of the wood pole. Structural elements such as a metal beam, a composite material beam, or a beam made of the same or of a different type of wood, for example, can also be integrated into the wood pole during manufacturing, for example, to provide wood poles having enhanced resistance characteristics. An insulating material can also be used in the longitudinal passage, for example. This can be advantageous, for example, if the pole is used horizontally in making the walls of a log house, for example.

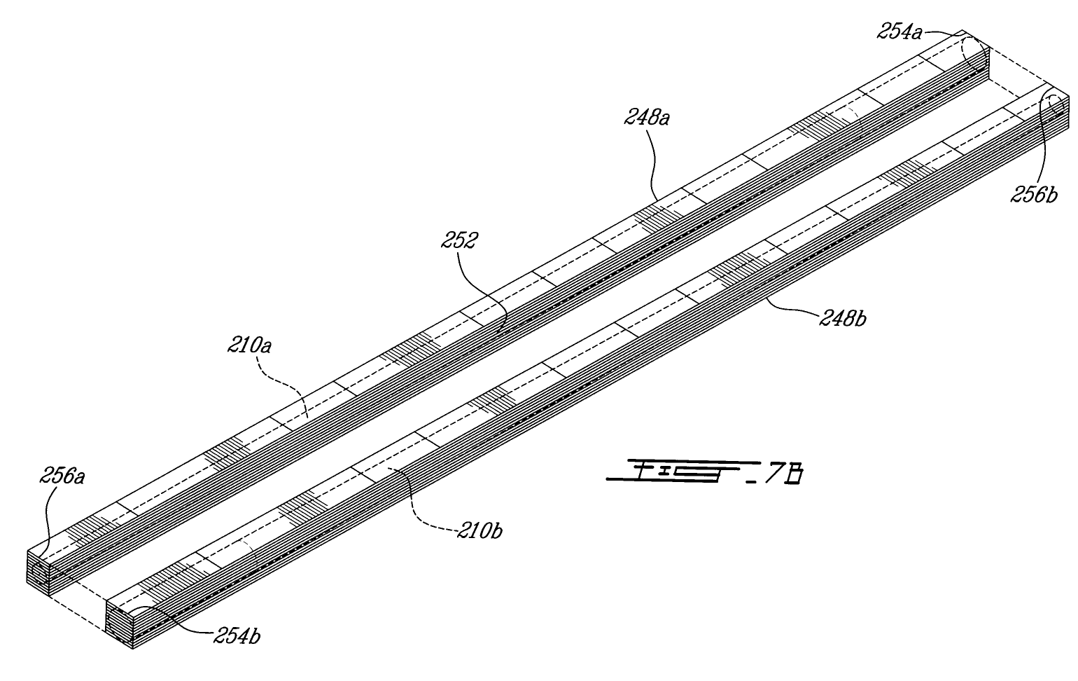

In accordance with an alternate example 210, shown in FIG. 7, a stack 248 having a constant rectangular cross-section of a width sufficient to accommodate two or more wood poles (210a, 210b) can be made. The stack 248 can then be separated into two or more elongated stacks 248a, 248b of substantially square cross-section, which can each accommodate a respective wood pole (210a, 210b). The elongated stacks 248a, 248b can thereafter be used as such, as poles having a somewhat square or rectangular cross-section, or can be turned to yield poles of solid of revolution shape. In the example shown in FIG. 7, the stack is designed to be separated with a sloping cut, to yield two stacks 210a, 210b each having an opposite broad end 254a, 254b and an opposite narrow end 256a, 256b, to each accommodate a base portion, and a narrower upper portion, respectively, of a pole, with reduced wood usage. The original stack 248, can be designed with one or more longitudinal passages therein, for the resulting poles 210a, 210b to have respective longitudinal passages, for example.

Tests have validated that the concept of making a pole from an assembly of wood boards is feasible. In particular, a pole 10 such as illustrated in FIG. 1 and made with a method such as described above was made. In this prototype, the side-joints 28 and end joints 46 (FIG. 3) were made using an isocyanate glue. The side-joints 28 were tongue-and-groove joints 28a, whereas the end joints 46 were finger-joints 46a. The face-joints 54 (FIG. 1B), were made using phenol-resorcinol formaldehyde glue. This test pole was tested following the norm ASTM 5456. It was first submerged in water at 3 bar pressure for 13 hours, until it fully absorbed humidity, and was then placed in an oven at 180° C. for 24 hours. The glue held and the pole 10 was found to successfully pass this test.

In alternate embodiments, any suitable glue can be used. For example, it is believed that phenol resorcinol formaldehyde glue, or formaldehyde melamin glue can be suitable in alternate applications. The glue should be adapted for the environment in which the pole will ultimately be used. For example, a frost-resistant glue may be required in certain climates. The glue can be structural or not, depending on the application. Different glues can be used for the different types of joints, if desired.

The examples described above and illustrated are provided for the purpose of explanation and illustration, and to facilitate comprehension. Many additional alternate embodiments are also possible.

For example, although the previous examples describe turning the pole subsequently to stacking, or face-joining the elongated panels, the step of turning is optional, and can be omitted in some applications where the pole does not require a solid of revolution shape. Alternately, only one or more portions of the pole can be turned, and the remaining portion or portions be left as such. Also, it will be understood that pole cross-sectional shapes other than those described above and illustrated can also be used in alternate embodiments.

The optional longitudinal passage, or any alternate cavity provided in the pole can have any desired shape. For example, a longitudinal passage of square or rectangular cross-section, or any other suitable cross-section, having any desired size can be used in the pole. The cross-section can also be irregular, and can alternately span along only a portion of the length of the pole.

The above described methods of assembly can be used to make the pole, but other methods can be used as well. For example, some applications are not as structurally-sensitive than others, and a method which results in joints which coincide between adjacent ones of the stacked panels can be suitable for such applications. In an example of such an alternate embodiment, long boards made of a plurality of end-joined wood boards can be assembled into elongated panels to form the pole, for instance.

The pole can be chemically treated for protection against decay, insects, etc. The wood boards can be treated prior to assembly into the pole, the pole can be treated as a whole, once assembled, or any portion of the pole can be treated at any suitable intermediate step of the assembling method.

Another possibility of the engineered pole is that different species of wood, or different grades of wood can be used at predetermined areas of the pole cross-section. For example, in some applications, it can be advantageous that the wood boards which form part of the outer portion of the pole have a greater structural resistance than the wood boards which form part of the core of the pole. To provide still another example, it can be useful in certain application to use a given species in the outer portion of the pole, and another species of wood in the core of the pole. For example, larch can be used in the core for the core to benefit from the degradation-resistance of this species, whereas jack pine can be used in the outer portion, for the outer portion to benefit from the chemical treatment absorption characteristics of the jack pine specie. Any alternate suitable combination of species can be used if desired.

In certain applications, it can be desired to cap one or both tips of the pole to reduce water infiltration in the wood boards, or to help prevent infiltration of water in the longitudinal passage in embodiments where a longitudinal passage is present. However, the capping is optional and can be omitted.

The examples described above and illustrated are thus exemplary only. The scope is indicated by the appended claims.

1.-30. (canceled)

31. A pole comprising a plurality of elongated panels face-joined in a stacked arrangement, the elongated panels being oriented longitudinally relative to an axis of the pole, each one of the elongated panels having a plurality of panel sections longitudinally joined end to end, each one of the panel sections having a plurality of transversally edge-joined wood boards having the same thickness but varying edge-to-edge widths, the elongated panels being face-joined to one another in the stacked arrangement in the direction of the thickness of the wood boards.

32. The pole of claim 31 wherein the pole has a solid of revolution shape centered on the axis of the pole.

33. The pole of claim 32 wherein the solid of revolution shape is cylindrical at a base portion of the pole.

34. The pole of claim 32 wherein the solid of revolution shape is truncated conical at an upper portion of the pole.

35. The pole of claim 31 wherein the panel sections are joined end to end in the elongated panels using finger joints.

36. The pole of claim 35 wherein the panel sections have varying lengths, and the longitudinal position of the finger joints in the elongated panels are longitudinally offset from the longitudinal position of the finger joints of adjacent elongated panels in the stack.

37. The pole of claim 31 wherein the wood boards are assembled edge to edge in the panel sections using tongue and groove joints.

38. The pole of claim 31 wherein the elongated panels are arranged in a regular stack spanning the entire thickness of the pole, transversally to the axis.

39. The pole of claim 31 further comprising a longitudinal passageway extending substantially centrally therethrough.

40. The pole of claim 39 wherein the longitudinal passageway is formed by a longitudinal discontinuity formed in one or more adjacent ones of the stacked elongated panels.

41. The pole of claim 31 wherein the wood boards of the elongated panels have joints which are substantially offset with the joints between the wood boards of at least one adjacent elongated panel in the stacked arrangement.

42. A method of making a pole comprising:
edge-joining a plurality of wood boards into panel sections;
longitudinally joining a plurality of the panel sections in an end to end relationship, thereby forming elongated panels;
face-joining a plurality of the elongated panels into an elongated stack, each one of the elongated panels being an assembly of substantially longitudinally-oriented wood boards.

43. The method of claim 42 further comprising turning the pole into a solid of revolution shape.

44. The method of claim 42 wherein the step of longitudinally joining includes finger-jointing the plurality of panel sections which have varying lengths.

45. The method of claim 44 wherein the edge-joined wood boards have varying widths but the same thickness.

46. The method of claim 42 wherein at least one of the elongated panels has a longitudinal discontinuity substantially at a longitudinal center thereof.

47. The method of claim 42 further comprising separating the pole substantially longitudinally, for obtaining two poles.

48. A method of making poles, comprising:
face joining a plurality of elongated panels into an elongated stack, each one of the elongated panels being comprised of an assembly of substantially longitudinally-oriented wood boards
separating the elongated stack substantially in the longitudinal direction into at least two poles by separating each one of the elongated panels.

49. The method of claim 48 wherein the separating includes cutting the elongated stack slightly obliquely relative to the longitudinal direction, for allowing opposite broader base portions and narrower upper portions of the at least two poles, one in each separated portion of the elongated stack.

50. The method of claim 48 further comprising turning each one of the at least two poles into a respective solid of revolution shape.
